(19) United States
(12) Patent Application Publication
(10) Pub. No.: US 2008/0059442 A1
(43) Pub. Date: Mar. 6, 2008

(54) SYSTEM AND METHOD FOR AUTOMATICALLY EXPANDING REFERENCED DATA

(75) Inventors: HONGLEI GUO, Beijing (CN); ZHI LI GUO, Beijing (CN); ZHONG SU, Beijing (CN)

Correspondence Address: Anne Vachon Dougherty, 3173 Cedar Road, Yorktown Hts, NY, 10598, US

(73) Assignee: International Business Machines Corporation, Armonk, NY (US)

(21) Appl. No.: 11/848,601

(22) Filed: Aug. 31, 2007

(30) Foreign Application Priority Data
Aug. 31, 2006 (CN) 200610128032.5

(51) Int. Cl. G06F 7/10

(52) U.S. Cl. 707/4; 707/E17.008

(57) ABSTRACT

A system and method for automatically extracting entity reference data from a data resource, which can incrementally mine new reference data tuples from the existing data sources (e.g. data warehouse, web, etc.) with low cost. The system of the invention includes an_entity data parsing means coupled with the data resource, for parsing the entity data within the data resource, to obtain an internal semantic structure of each entity data and generate a feature set from the internal semantic structure; and data extraction means for extracting the reference entity data according to the feature set generated by the entity data parsing means. Further, a survival component may be provided to optimize candidate reference data seeds output from the data extraction means.

### FIELD OF THE INVENTION

The present invention relates to the data processing field, and more particularly, to a system and method for expanding reference data.

### BACKGROUND OF THE INVENTION

Decision support analysis on data warehouses influences important business decisions. Therefore, the accuracy of such analysis is crucial. However, data received at the data warehouse from external sources usually contains errors, e.g. spelling mistakes, inconsistent conventions across data sources, missing fields. Consequently, a significant amount of time and money are spent on data cleaning (i.e. detecting and correcting errors in data).

In this aspect, a common technique validates incoming data tuples against a reference data dictionary (i.e. relation table) consisting of known-to-be-clean tuples to standardize the incoming data tuples. A reference data dictionary can be a source of rich vocabularies and structures within attribute values. The reference data dictionary may be internal to a data warehouse or obtained from external sources (e.g. valid address relations from postal departments). For example, a reference dictionary usually comprises pre-recorded canonical names (e.g. company name, product name, location etc.) and description fields. Obviously, a large-scale reference data will provide a better support for data cleaning. A huge amount of new reference entity entries appear rapidly in typical data warehouse application environments. Only a small amount of the new entries can be collected in the existing predefined reference data dictionary. It is difficult and expensive to manually collect the huge amount of new reference entity entries (e.g. new customer name, company name, product name, domain-specific entity name).

Therefore, reference data set expansion and update is still a bottleneck for various task-oriented or domain-oriented data mining applications. One of the most prominent problems in data cleaning and analytics is how to automatically expand the reference data set. However, there is no existing means for automatically expanding and updating the reference data set in the art.

### SUMMARY OF THE INVENTION

In view of the above problems in the prior art, the present invention provides a system and method for automatically expanding reference data. This system and method can automatically expand the reference data with low cost by incrementally mining new reference tuples from the existing data sources (e.g. data warehouse, web, domain specific data set, etc.).

According to an aspect of the invention, a system for automatically extracting reference entity data from a data resource is provided, comprising: entity data parsing means coupled with the data resource, for parsing the entity data within the data resource, to obtain an internal semantic structure of each entity data and generate a feature set from the internal semantic structure; and data extraction means for extracting the reference entity data according to the feature set generated by the entity data parsing means.

According to another aspect of the invention, a method for automatically extracting reference entity data from a data resource is provided, comprising the steps of: parsing the entity data within the data resource, to obtain an internal semantic structure of each entity data and generate a feature set from the internal semantic structure; and extracting the reference entity data according to the feature set generated from parsing the entity data.

According to yet another aspect of the invention, a computer program product is provided, comprising instructions stored on one or more computer readable medium usable in a computer system, which implement the steps of the method according to the invention when executed in the computer.

According to the invention, the reference data is expanded automatically by collecting new reference tuples from the existing data resources (e.g. data warehouse, web, domain-specific dataset etc.). The invention provides an easy-to-use and effective mechanism to expand the reference data. This system can mine more new reference tuples from the existing data sources (e.g. data warehouse, web etc.) with low cost.

### BRIEF DESCRIPTION OF THE DRAWINGS

FIG. 1 is an overall block diagram showing an automatic reference data expansion system according to the invention;

FIG. 2 is a block diagram showing the structure of an expansion component of the automatic reference data expansion system according to the invention;

FIG. 3 is a block diagram showing the structure of a survival component of the automatic reference data expansion system according to the invention;

FIG. 4 shows an example of extracting new entity reference data from a Chinese data set by the expansion component;

FIG. 5 shows an example of extracting new entity reference data from an English data set by the expansion component; and

FIG. 6 is a method flowchart showing a preferred embodiment according to the invention.

### DETAILED DESCRIPTION OF THE PREFERRED EMBODIMENT

The meaning of terms used in the invention is given below before describing preferred embodiments of the invention with reference to the accompanying drawings.

Reference data dictionary: a typical storage form of the reference data and is also called “reference table” or “reference relations” in data warehouse applications. The reference data dictionary can be a source of rich vocabularies and structures within attribute values. For example, a product reference data dictionary usually contains pre-recorded canonical names of products.

Reference data entry collection specification: the requirement specification of the reference data collection, e.g. domain category, data type, language, etc.

Reference data sample seed list: an initial list of samples that one is looking for, such as named entities, domain-specific entities, etc.

Entity: an object or an event about which information is stored, for example, person name, location, company name, product name, etc.

Alias: names of an entity different from its standard name, for example, legacy names, abbreviations, short forms, commonly misused names.

The preferred embodiments of the invention will be described in detail below with reference to the accompanying drawings.

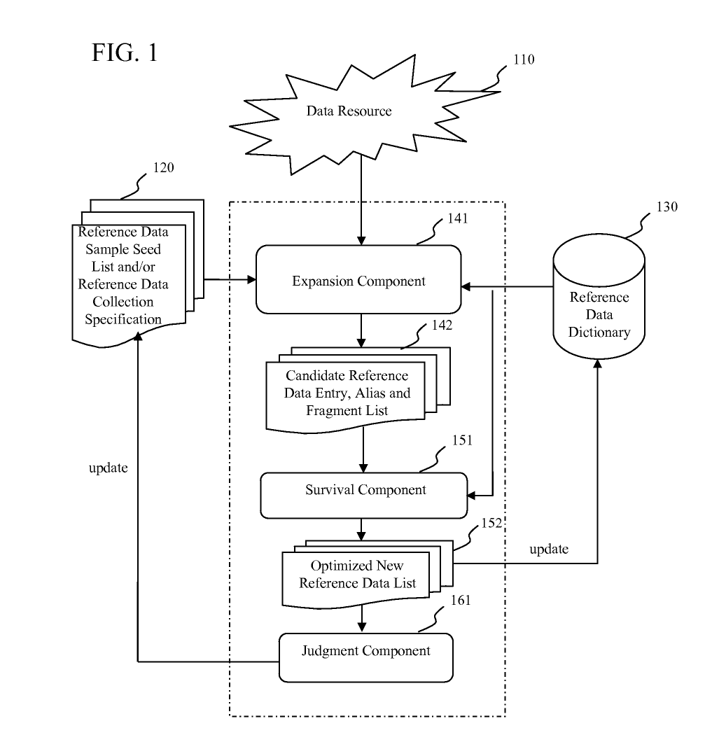

FIG. 1 shows an overall block diagram of the automatic entity reference data expansion system according to the invention. As shown in FIG. 1, the system according to the invention comprises an expansion component 141, and preferably, a survival component 151 and a judgment component 161.

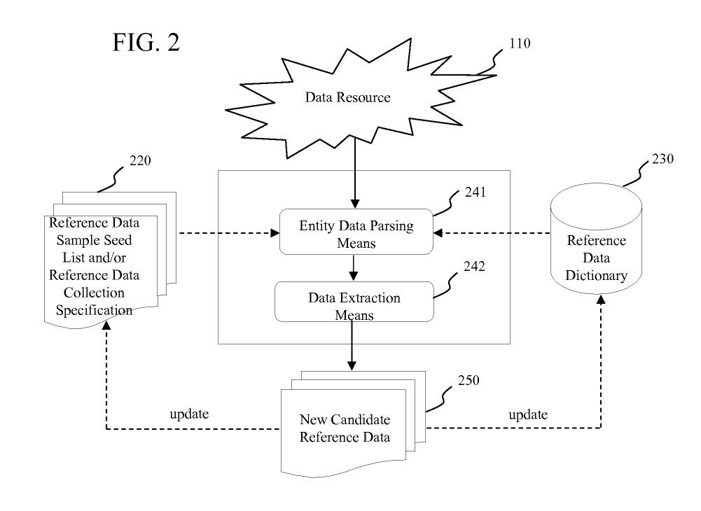

The expansion component 141 is coupled with a data resource 110 for automatically extracting new entity reference data entries from the data resource 110. Before describing other components in FIG. 1, the specific structure of the expansion component 141 is described with reference to FIG. 2.

As shown in FIG. 2, the expansion component 141 comprises entity data parsing means 241 and data extraction means 242. The entity data parsing means 241 is coupled with the data resource 110, for parsing the entity data within the data resource 110, to obtain an internal semantic structure of each entity data and generate a feature set from the internal semantic structure. The feature set is fed to the data extraction means 242 such that the data extraction means 242 extracts the reference entity data based on the feature set.

Here, the term “internal semantic structure” refers to relationships between each linguistic unit (including but not limited to words, characters, phrases, fragments) in each entity data from a semantics viewpoint, rather than only a shallow literal relationship between the language units. The “feature set” covers features of the entity data in multiple levels such as words, characters, phrases, fragments, context-fragments and named entity attributes, which can provide features for candidate reference data extraction.

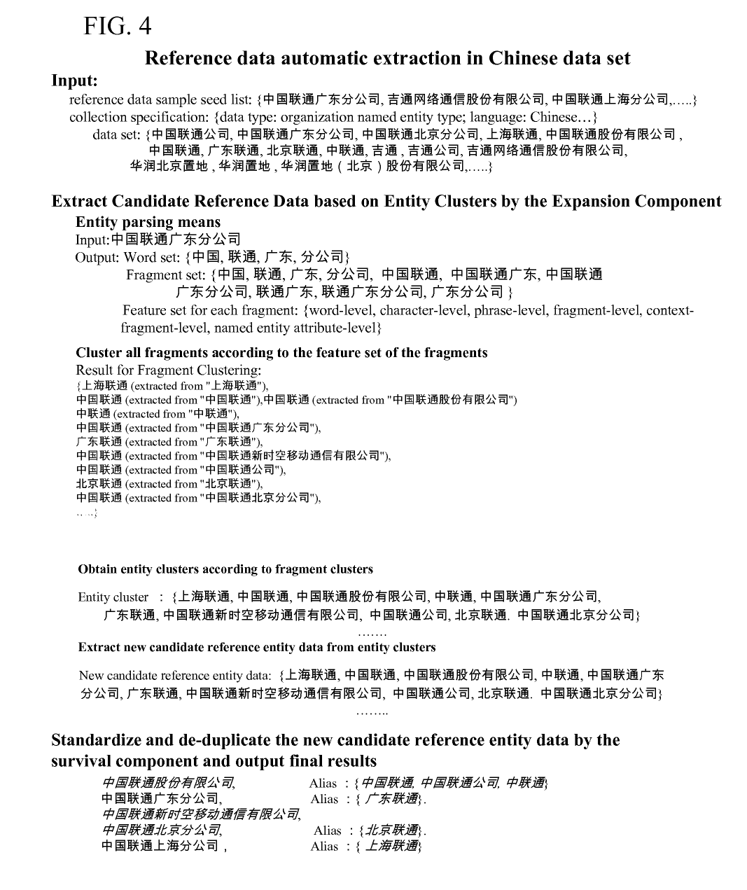

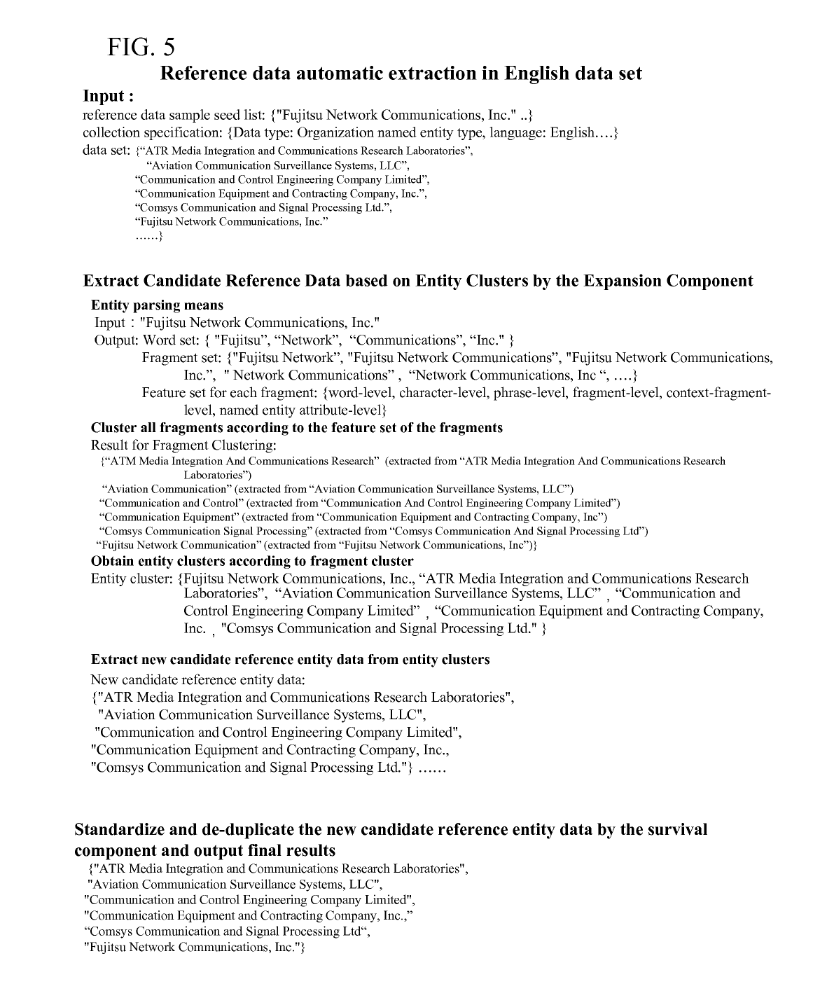

It is to be noted that, the operation of the entity data parsing means 241 according to the invention is language independent and is applicable to various natural languages (as shown in examples described below with reference to FIGS. 4 and 5). In addition, it shall be appreciated that, the present technical field has provided a plurality of algorithms to parse the entity data to obtain the internal semantic structure of each entity data and to generate the feature set from the internal semantic structure, the details of which are omitted here.

According to a preferred embodiment of the invention, in order to set a limit on the range of the reference data to be extracted (for example, extracting which specific type of reference data and from what data set to extract the reference data), the entity data parsing means 241 is further coupled with a reference data sample seed list and/or reference data collection specification 220 (collectively denoted by a sign 220). The reference data sample seed list defines samples of the reference data to be collected, for example, [symbol] [symbol] [symbol] [symbol] as shown in FIG. 4, and the reference data collection specification defines the data set from which the reference data is collected, for example, the collection specification as shown in FIG. 4: {data type: organization named entity type; language: Chinese . . . }.

In addition, in order to improve the efficiency and quality of parsing, the entity data parsing means 241 is further coupled with an existing reference data dictionary 230. For example, on the assumption that the existing reference data dictionary has such an entity data as [symbol] the entity data parsing means 241 will treat the [symbol] as an information element in the parsing process and will not sub-divide it into single words like [symbol] [symbol] and

[symbol]

Preferably, the entity data parsing means 241 parses the entity data in the data resource 110 and generates the feature set, by making reference to the reference data sample seed list and/or reference data collection specification 220 as well as the existing reference data dictionary 230. The feature set is fed to the data extraction means 242 to extract the entity reference data. According to the invention, the data extraction means 242 can extract the entity reference data by various means, e.g. clustering approach and/or probabilistic approach.

When the clustering approach is used, the data extraction means 242 extracts new candidate entity data entries by clustering the features in the feature set, according to information given by the feature set (including but not limited to the entity type, entity internal semantic structure and attributes, available entity co-reference chains, common representative reference entity fragments), and possibly also according to the existing reference data dictionary and alias list.

Theoretically, the data extraction means 242 can extract the entity reference data by clustering various levels (words, characters, phrases, fragments, entity etc.) of the feature set, however, according to the preferred embodiment of the invention, the data extraction means 242 extracts the entity reference data by clustering in two levels: fragment level and entity level. The fragment is a larger language unit binding words, characters and/or phrases in the entity data, and it generally will form an alias for a standard entity data (for example, for the entity data [symbol] [symbol] the fragment [symbol] contained therein is its short form). Therefore, by including the data in the fragment level in the entity data, data loss can be avoided to thereby improve the efficiency of reference data expansion.

When extracting the entity reference data from both the fragment and entity levels, the data extraction means 242 can be sub-divided into fragment extraction means and entity extraction means (not shown). Specifically, the fragment extraction means is used for clustering fragments in the feature set, while the entity extraction means is used for obtaining entity clusters according to the fragment clusters.

Those skilled in the art would appreciate that, “clustering” is a mature technique in the related art. For detailed information regarding the clustering technique, please see for example “A Comparison of Document Clustering Techniques” (Michael Steinbach, George Karypis, Vipin Kumar, Department of Computer Science and Engineering, University of Minnesota, Technical Report #00-034, 2000), the entire contents of which are incorporated herein by reference.

When the probabilistic approach is used, the data extraction means 242 performs statistic analysis on all candidate entity entries according to the frequency of occurrence of the fragment, information given by the feature set (including but not limited to the entity type, entity internal semantic structure and attributes, available entity co-reference chains, common representative reference entity fragments), and possibly also according to the existing reference data dictionary and alias list, and automatically extracts the entity reference data from probabilistic analysis results.

The probabilistic approach is also a mature technique in the related art. Detailed information regarding the probabilistic technique, please see for example “Is Knowledge-Free Induction of Multiword Unit Dictionary Headwords a Solved Problem?” (Patrick Schone and Daniel Jurafsky, University of Colorado, Boulder Colo. 80309, Proceedings of Empirical Methods in Natural Language Processing, 2001), the entire contents of which are incorporated herein by reference.

The above has respectively described the situation in which the clustering approach or probabilistic approach is used to extract the new entity reference data. However, those skilled in the art would easily appreciate that, it is also possible to combine the two approaches to extract new entity reference data.

Having described the structure of the expansion component 141 with reference to FIG. 2, the structure of the system according to the invention will be described below with reference to FIG. 1.

The entity entries extracted by the data extraction means 242 can be directly used for updating the existing reference data (generally stored in the form of the reference data dictionary) and/or updating the reference data sample seed list. However, since the entity entries extracted by the data extraction means 242 may comprise the situation in which duplicate entity data, standard name and alias of the entity data exist simultaneously, using such data to update the reference data dictionary will bring data redundancy. Therefore, according to the preferred embodiment of the invention, the system further comprises a survival component 151 for optimizing preferred reference data entries extracted by the expansion component 141.

The role of the survival component 151 is for example to standardize the extracted candidate reference data entries (including but not limited to complement missing fields and replace alias with standard names) and de-duplication processes, with reference to the existing reference data dictionary, such that in the reference data dictionary, each entity data has a standard name, and such information as the corresponding alias may be stored as its attribute.

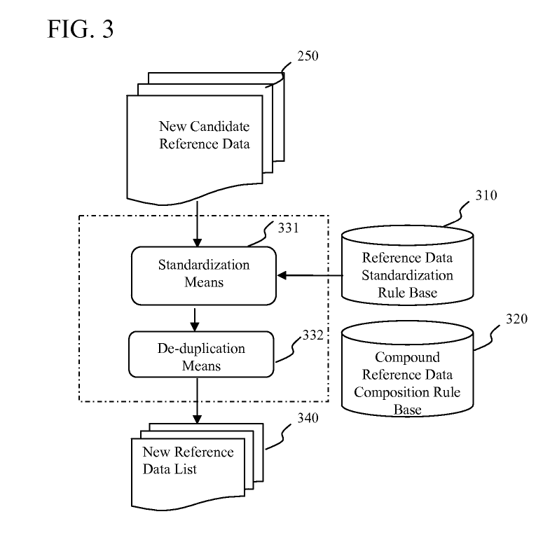

The structure of the survival component 151 according to the invention will be described in detail with reference to FIG. 3, before describing other components in FIG. 1.

As shown in FIG. 3, the survival component 151 comprises standardization means 331 and de-duplication means 332.

According to the preferred embodiment of the invention, the standardization means 331 standardizes the new reference data entries according a reference data standardization rule base 310 and a compound reference data entry composition rule base 320. The standardization operation comprises complementing missing fields in the entry, replacing a common name with the standardization name of the entity, etc.

The de-duplication means 332 is used for removing duplicate instances from the standardized new reference data entry set such that each entity reference data appears only once in the reference data dictionary.

It should be appreciated that, the standardization and de-duplication processes can be achieved by many approaches known in the art, details of which are omitted here.

Having described the structure of the survival component 151 according to the invention with reference to FIG. 3, the structure of the system according to the invention will be continuously described below with reference to FIG. 1.

According to the preferred embodiment of the invention, the system can further comprise a judgment component 161. The judgment component 161 is used for judging whether or not a condition for causing the expansion component 141 to stop extracting the new entity reference data from the data resource is satisfied. For example, when the number of the new reference data entries found each time by the expansion component 141 is less than a predetermined threshold (for example, when there is substantially no potential new entity reference data entry in the data resource 110), the judgment component 161 can inform the expansion component 141 to stop its operation.

The operation of extracting the entity reference data by the expansion component 141 in FIG. 2 by means of the clustering approach is described below with reference to the examples of FIGS. 4 and 5. As described before, the operation of the expansion component is language independent. Therefore, FIG. 4 shows a first example of extracting new entity reference data from a Chinese data set by the expansion component 141, and FIG. 5 shows a second example of extracting new entity reference data from an English data set by the expansion component 141.

### FIRST EXAMPLE

In the example shown in FIG. 4, an input to the entity data parsing means 241 of the expansion component 141 comprises the following three parts:
1) a reference data seed list including the following seeds:

[symbol] [symbol] [symbol] [symbol] [0052] 2) a reference data collection specification, defining that data of a Chinese organization named entity type are to be collected
3) a data set (i.e. data resource) including the following data:

[symbol]

[symbol]

[symbol]

[symbol]

[symbol]

[symbol]

[symbol]

[symbol]

[symbol]

[symbol]

[symbol]

[symbol]

Let's use the entity [symbol] [symbol] to illustrate how the entity data parsing means 241 parses it to obtain its internal semantic structure, and extracts the reference entity entry, reference entity fragment and relevant feature set thereof according to the internal semantic structure, reference data sample seed list and collection specification. The major steps are as follows:
word set: [symbol] [symbol]
fragment set: [symbol] [symbol] [symbol] [symbol] [symbol] [symbol]
feature set for each fragment: {word-level, character-level, phrase-level, fragment-level, context-fragment-level, named entity attribute-level, . . . }.

Then, the entity data parsing means provides the feature set of the extracted reference entities and reference fragments to the data extraction means 242. The data extraction means 242 extracts a candidate list of reference entities by means of the clustering approach, according to the entity type, entity internal semantic structure and attributes, available entity co-reference chains, common representative reference entity fragment, existing reference data dictionary and alias list. Fragment clusters are first generated by fragment extraction means based on the feature set of these fragments, then entity clusters are obtained by entity extraction means based on the fragment clusters. For the inputs of this example, one of the fragment clusters is as follows:

[symbol] (extracted from

[symbol]

[symbol] (extracted from

[symbol]

[symbol] (extracted from

[symbol]

[symbol]

[symbol] (extracted from

[symbol]

[symbol] (extracted from

[symbol]

[symbol]

[symbol] (extracted from

[symbol]

[symbol] (extracted from

[symbol]

[symbol]

[symbol] (extracted from

[symbol]

[symbol] (extracted from

[symbol]

[symbol] (extracted from

[symbol]

[symbol]

The entity cluster obtained from the above fragment cluster is as follows:

[symbol]

[symbol]

[symbol]

[symbol]

[symbol]

[symbol]

[symbol]

[symbol]

[symbol]

Subsequently, new reference entity data are extracted from the entity cluster:

[symbol]

[symbol]

[symbol]

[symbol]

[symbol]

[symbol]

[symbol]

[symbol]

[symbol]

After the new reference entity data are extracted, the survival component 151 standardizes and de-duplicates it to obtain final reference data results as follows (in which the entity reference data in italics is the newly extracted entity reference data):

[symbol] [symbol] Alias:

[symbol]

[symbol]

[symbol] [symbol] Alias:

[symbol]

[symbol]

[symbol]

[symbol] [symbol] Alias:

[symbol]

### SECOND EXAMPLE

In the example as shown in FIG. 5, an input to the entity data parsing means 241 of the expansion component comprises the following three parts:

1) a data set (i.e. data resource) including the following data:

{
“ATR Media Integration and Communications Research Laboratories”,
“Aviation Communication Surveillance Systems, LLC”,
“Communication and Control Engineering Company Limited”,
“Communication Equipment and Contracting Company, Inc.”,
“Comsys Communication and Signal Processing Ltd.”,
“Fujitsu Network Communications, Inc.”
......
}

2) a reference data sample seed list including the following seeds:

{Fujitsu Network Communications, Inc. . . . };
3) a reference data collection specification defining that data of an English organization naming entity type are to be collected.

In the above input, for example, for the entity data “Fujitsu Network Communications, Inc”, the entity data parsing means 241 parses it to obtain its internal semantic structure, and extracts the reference entity entry, reference entity fragment and feature set thereof according to the internal semantic structure, reference data sample seed list and collection specification:
Word set: {“Fujitsu”, “Network”, “Communications”, “Inc.”}
Fragment set: {“Fujitsu Network”, “Fujitsu Network Communications”, “Fujitsu Network Communications, Inc.”, “Network Communications”, “Network Communications, Inc”, . . . }
Feature set for each fragment: {word-level, character-level, phrase-level, fragment-level, context-fragment-level, named entity attribute-level, . . . }.

Then, the entity data parsing means 241 provides the extracted reference entity entries, reference entity fragments and feature set thereof to the data extraction means 242. The data extraction means 242 extracts a candidate entity reference data entry by means of the clustering approach, according to the entity type, entity internal semantic structure and attributes, available entity co-reference chains, common representative reference entity fragments, existing reference data dictionary and alias list. In the example shown in FIG. 5, first, the fragment extraction means clusters all the fragments according to the feature set of the fragments, then, the entity extraction means obtains entity clusters according to fragment clusters, that is,

Fragment Cluster:

{“ATM Media Integration And Communications Research” (extracted from “ATR Media Integration And Communications Research Laboratories”)

“Aviation Communication” (extracted from “Aviation Communication Surveillance Systems, LLC”)

“Communication and Control” (extracted from “Communication And Control Engineering Company Limited”)

“Communication Equipment” (extracted from “Communication Equipment and Contracting Company, Inc”)

“Comsys Communication Signal Processing” (extracted from “Comsys Communication And Signal Processing Ltd”)

“Fujitsu Network Communication” (extracted from “Fujitsu Network Communications, Inc”)

Entity Cluster: {Fujitsu Network Communications, Inc., “ATR Media Integration and Communications Research Laboratories”, “Aviation Communication Surveillance Systems, LLC”, “Communication and Control Engineering Company Limited”, “Communication Equipment and Contracting Company, Inc., “Comsys Communication and signal Processing Ltd.”}.

Subsequently, new reference entity data are automatically extracted from the entity cluster:

{“ATR Media Integration and Communications Research Laboratories”, “Aviation Communication Surveillance Systems, LLC”, “Communication and Control Engineering Company Limited”, “Communication Equipment and Contracting Company, Inc.”, “Comsys Communication and Signal Processing Ltd.”}.

After the new reference entity data are extracted, the survival component 151 standardizes and de-duplicates it to obtain final reference data results (in which the entity reference data in italics are the newly extracted entity reference data):

{“ATR Media Integration and Communications Research Laboratories”,

“Aviation Communication Surveillance Systems, LLC”,

“Communication and Control Engineering Company Limited”,

“Communication Equipment and Contracting Company, Inc.”,

“Comsys Communication and Signal Processing Ltd.”,

Fujitsu Network Communications, Inc. . . . ”}.

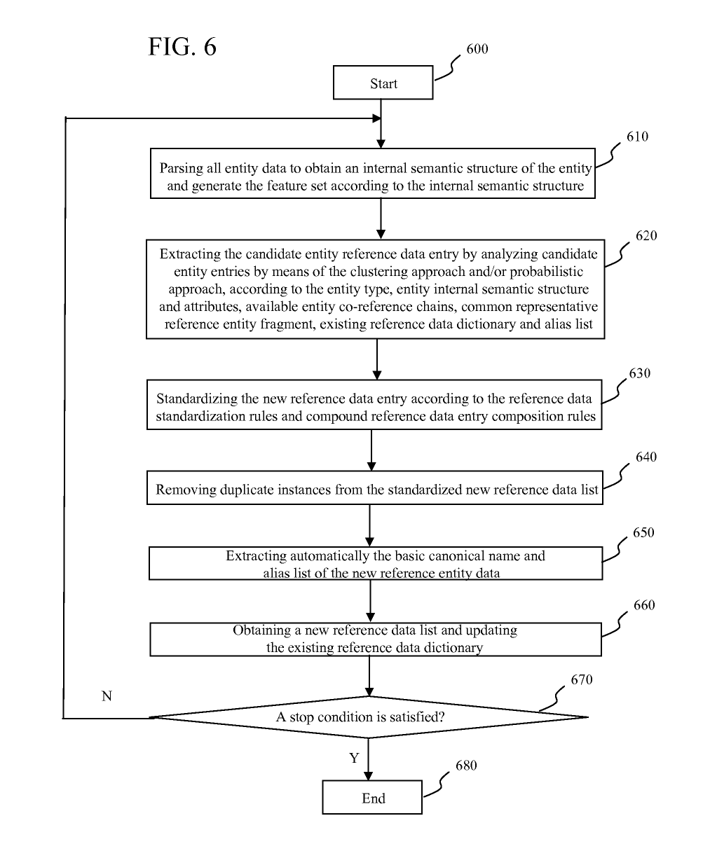

The method flow of the preferred embodiment according to the invention will be described below with reference to FIG. 6. The method starts at step 600 and then proceeds to step 610. In step 610, the entity data parsing means parses the entity data in the data resource to obtain the internal semantic structure of the entity and extract the entity entry, entity fragment and feature set thereof according to the internal semantic structure, reference data sample seed list and reference data collection specification. Then, in step 620, the data extraction means extracts the candidate entity reference data entries by means of the clustering approach and/or probabilistic approach, according to the entity type, entity internal semantic structure and attributes, available entity co-reference chains, common representative reference entity fragment, existing reference data dictionary and alias list. Later, in step 630, the standardization means standardizes the new reference data entry according to the reference data standardization rule and compound reference data entry composition rule, and in step 640, duplicate instances are removed from the standardized new reference data sample seed list. Then, in step 650, the basic canonical name and alias list of each entity are extracted automatically. Next, in step 660, a new reference data sample seed list is obtained and the existing reference data dictionary is updated. Then, in step 670, it is judged whether or not a stop condition is satisfied (for example, if the newly extracted reference data seed ratio is less than a predefined threshold). If the result is “YES” in step 670, then the operation of the method according to the invention is finished in step 680; otherwise (i.e. the result in step 670 is “NO”), the method returns to step 610 to repeat the operations of FIG. 6.

Those skilled in the art would appreciate that, the embodiment of the invention can be provided in the form of a method, system or computer program product. Therefore, the invention may adopt the form of an all-hardware embodiment, all-software embodiment or combined software and hardware embodiment. A typical combination of hardware and software comprises a universal computer system with a computer program which is loaded and executed to control the computer system to execute the above method.

The present invention may be embedded in the computer program product that incorporates all the features enabling the method described herein to implement. The computer program product is contained in one or more computer readable storage medium (including but not limited to a disk memory, CD-ROM, optical memory etc.) that has computer readable program codes stored therein.

The present invention has been described with reference to the flowchart and/or block diagram of the method, system and computer program product according to the invention. Each block in the flowchart and/or block diagram and a combination of the blocks in the flowchart and/or block diagram obviously can be achieved by computer program instructions. These computer program instructions may be provided to a universal computer, dedicated computer, embedded type processor or processors of other programmable data processing equipments, to generate a machine to thereby instruct (through the computer or processors of other programmable data processing equipments) to generate means for achieving functions specified in one or more blocks in the flowchart and/or block diagram.

These computer program instructions may be stored in a readable memory of one or more computer that can instruct the computer or other programmable data processing equipments to exert themselves in a particular way, such that the instructions stored in the computer readable memory generate a manufactured product that comprises means for achieving the instructions of the functions specified in one or more blocks in the flowchart and/or block diagram.

These computer program instructions may be loaded into one or more computer or other programmable data processing equipments, such that a series of operation steps are executed in the computer or other programmable data processing equipments, to thereby generate a computer-implemented process in each such equipment, so that the instructions executed in the equipment provide for the steps specified in one or more blocks in the flowchart and/or block diagram.

The above has described the principle of the invention in conjunction with the preferred embodiments of the invention, which, however, is illustrative and cannot be construed as limiting the invention. Various changes and variations may be made to the invention by those skilled in the art without departing from the spirit and scope of the invention as defined in accompanying claims.

1. A system for automatically extracting reference entity data from a data resource, comprising:
entity data parsing means coupled with the data resource, for parsing the entity data within the data resource, to obtain an internal semantic structure of each entity data and generate a feature set from the internal semantic structure; and
data extraction means for extracting the reference entity data according to the feature set generated by the entity data parsing means.

2. A system according to claim 1, wherein the data extraction means extracts the reference entity data from said data by means of a clustering approach and/or probabilistic approach.

3. A system according to claim 1, wherein the entity data parsing means is coupled with at least one of a reference data sample seed list, reference data collection specification and existing reference data dictionary, wherein the reference data sample seed list is used for defining samples of the entity reference data to be extracted, the reference data collection specification is used for defining a data set from which the reference data is extracted, and the existing reference data dictionary serves as a basis for parsing the entity data within the data resource by the entity data parsing means.

4. A system according to claim 1, wherein the data extraction means further comprises:
fragment extraction means for extracting fragment entries in the entity data according to the feature set; and
entity extraction means for extracting entity data to which the fragment entries correspond.

5. A system according to claim 4, wherein the fragment extraction means further comprises:
means for clustering the fragments according to at least one of the following: an entity type, entity internal semantic structure and attributes, available entity co-reference chains, common representative reference entity fragments, existing reference data dictionary and alias list.

6. A system according to claim 4, wherein the fragment extraction means further comprises:
means for performing statistic analysis on the fragments according to at least one of the following: an entity type, entity internal semantic structure and attributes, available entity co-reference chains, common representative reference entity fragments, existing reference data dictionary and alias list.

7. A system according to claim 1, wherein the entity reference data extracted by the data extraction means is used to update the existing reference data dictionary and/or reference data sample seed list.

8. A system according to claim 1, further comprising:
a survival component for optimizing candidate reference entity data output from the data extraction means.

9. A system according to claim 8, wherein the survival component comprises:
standardization means for standardizing the candidate reference entry data according to a reference data standardization rule base and/or a compound reference data entry composition rule base.

10. A system according to claim 8, wherein the survival component comprises:
de-duplication means for removing duplicate instances from the candidate reference entity data.

11. A system according to claim 1, further comprising:
a judgment component for judging whether or not a condition of stopping new entity reference data extraction using the data extraction means is satisfied.

12. A method for automatically extracting reference entity data from a data resource, comprising the steps of:
parsing the entity data within the data resource, to obtain an internal semantic structure of each entity data and generate a feature set from the internal semantic structure; and
extracting the reference entity data according to the feature set generated from parsing the entity data.

13. A method according to claim 12, wherein the reference entity data is extracted from said data by means of a clustering approach and/or probabilistic approach.

14. A method according to claim 12, wherein the entity data is parsed with reference to at least one of a reference data sample seed list, reference data collection specification and existing reference data dictionary, wherein the reference data sample seed list is used for defining samples of the entity reference data to be extracted, the reference data collection specification is used for defining a data set from which the reference data is extracted, and the existing reference data dictionary serves as a basis for parsing the entity data within the data resource.

15. A method according to claim 12, wherein extracting the reference entity data according to the feature set generated from parsing the entity data further comprises the step of:
extracting fragment entries in the entity data from the feature set; and
extracting entity data to which the fragment entries correspond.

16. A method according to claim 15, wherein the step of extracting fragment entries in the entity data according to the feature set further comprises:
clustering the fragments according to at least one of the following: an entity type, entity internal semantic structure and attributes, available entity co-reference chains, common representative reference entity fragments, existing reference data dictionary and alias list.

17. A method according to claim 15, wherein the step of extracting fragment entries in the entity data according to the feature set further comprises:
performing statistic analysis on the fragments according to at least one of the following: an entity type, entity internal semantic structure and attributes, available entity co-reference chains, common representative reference entity fragments, existing reference data dictionary and alias list.

18. A method according to claim 12, further comprising updating the existing reference data dictionary and/or reference data sample seed list with the extracted entity reference data.

19. A method according to claim 12, further comprising the step of:
optimizing the candidate reference entity data according to the feature set.

20. A method according to claim 19, wherein the optimizing step comprises:
standardizing the candidate reference entry data according to a reference data standardization rule base and a compound reference data entry composition rule base.

21. A method according to claim 19, wherein the optimizing step comprises:
removing duplicate instances from the candidate reference entity data.

22. A method according to claim 12, further comprising:
judging whether or not a condition for stopping extracting new entity reference data is satisfied.

23. A computer program product comprising computer executable programs stored on a computer accessible medium which, when executed by computer, performs a method for automatically extracting reference entity data from a data resource, the method comprising the steps of:
parsing the entity data within the data resource, to obtain an internal semantic structure of each entity data and generate a feature set from the internal semantic structure; and
extracting the reference entity data according to the feature set generated from parsing the entity data.
